(19) United States
(12) Patent Application Publication
(10) Pub. No.: US 2015/0161139 A1
(43) Pub. Date: Jun. 11, 2015

(54) DATA SEARCH PROCESSING

(71) Applicant: Alibaba Group Holding Limited, Grand Cayman (KY)

(72) Inventors: Yong Wang, Hangzhou (CN); Xi Chen, Hangzhou (CN); Jianguo Lin, Hangzhou (CN); Haihong Tang, Hangzhou (CN); Anxiang Zeng, Hangzhou (CN); Xiaoyi Zeng, Hangzhou (CN); Chunxiang Pan, Hangzhou (CN); Yi Wang, Hangzhou (CN); Bo Wang, Hangzhou (CN); Yang Gu, Hangzhou (CN); Yinghui Xu, Hangzhou (CN)

(21) Appl. No.: 14/564,959

(22) Filed: Dec. 9, 2014

(30) Foreign Application Priority Data
Dec. 10, 2013 (CN) 201310674206.8

(51) Int. Cl. G06F 17/30

(52) U.S. Cl. CPC G06F 17/3053

(57) ABSTRACT

A search request sent by a user is received to obtain one or more query words included in the search request. Historical operating information relating to a data object in a search result corresponding to the query words is conducted statistics. An attribute of the data object is selected as a specified attribute to generate a probability distribution model of the attribute value on the specified attribute of the data object. A respective probability corresponding to the attribute value of each data object on the specific attribute in the research result corresponding to the search request sent by the current user is calculated by using the probability distribution model. The output rank of the data objects in the search result is adjusted by using the probability. The present techniques improve reasonability of displaying the data objects in the search result and provide more accurate result.

### CROSS REFERENCE TO RELATED PATENT APPLICATION

This application claims foreign priority to Chinese Patent Application No. 201310674206.8 filed on Dec. 10, 2013, entitled “Data Search Processing Method and System,” which is hereby incorporated by reference in its entirety.

### TECHNICAL FIELD

The present disclosure relates to the field of data search, and, more particularly, to a data search processing method and system.

### BACKGROUND

Along with the continuous improvement of Internet infrastructure and continuous development of computer networking technology, online network searching of various specific data information is gradually becoming one of the most commonly modes used by general Internet users. When the data volume is very large, users may click a user interface of a search engine to select a category or input search query words, and the search engine may rapidly find desired data objects.

When a user inputs a key work or selects a category at the user interface of the search engine, the search engine may return a searched display list including one or more data objects (search results). Generally, display information of each data object may include one or more attributes, attribute values, and other parameter information of the data object. After the search engine finds data objects, the search engine may rank and display the data objects according to attributes and attribute values of the data objects. For example, the data objects may include identification (ID), image, description, label and other attributes, and corresponding contents or attribute values, such as a specific number of an ID, specific contents of the images, specific description contents, word count, label sizes, etc. Therefore, the search engine may rank the data objects according to a number of images, description words or label sizes, etc., and display images, description, and labels of the data objects. Generally, among attribute values of attributes of the displayed data objects, one or more attributes have significant impact on the next step of operation of the user. For example, when using a search engine for searching final exam scores, the user may be more concerned with the attribute of the searched total score of a certain student. For another example, when using the search engine for searching products, the user often may be more concerned with the searched price of a certain product object. When the user finds out that prices (attribute values) of product objects, which are obtained through a product search engine, are beyond an actual price range, the user may probably question the search results and further abandon the operation of the search results. Particularly when a large amount of such search results occurs in a network search platform or such search results occur frequently, the users may worry about the security and reliability of the current search platform. Particularly when the data objects provided by the search platform are not from providers that pass reliability and security verification, the users may feel that the data objects are untrue, invalid, or even potentially safety hazards of network data (such as false attribute values soliciting the users to select the data objects to cause intrusion of malicious programs).

In addition, in the prior art, in order to solve the distortion of certain attribute values of the data objects, certain network search platforms mine and collate the attribute values through manual work and then display the attribute values to the users. A reasonability of such collation, however, is difficult to identify. Certain network search platforms conduct manual review of the attribute values and then display the attribute values to the users. For massive data, such conventional techniques are difficult and low in efficiency.

### SUMMARY

This Summary is provided to introduce a selection of concepts in a simplified form that are further described below in the Detailed Description. This Summary is not intended to identify all key features or essential features of the claimed subject matter, nor is it intended to be used alone as an aid in determining the scope of the claimed subject matter. The term “techniques,” for instance, may refer to apparatus(s), system(s), method(s) and/or computer-executable instructions as permitted by the context above and throughout the present disclosure.

The present disclosure provides improved data search processing methods and systems to improve a display process of data search and a reasonability of sorting display of searched data objects and to provide more accurate search results. The present techniques further reduce the risk of network searching and accessing of user, and further solve the problem of enhancing the security and reliability of search platforms.

According to one aspect, the present disclosure provides an example data search processing method. A search request sent by a current user is received to obtain one or more query words included in the search request. Historical operating information related to a data object in a search result corresponding to the query words is used for statistics. An attribute of the data object is selected as a specified attribute to generate a probability distribution model of the attribute value of the specified attribute of the data object related to the historical operating information corresponding to the query words. A respective probability corresponding to the attribute value of each data object on the specific attribute in the research result corresponding to the search request sent by the current user is calculated by using the probability distribution model. The output rank of the data objects in the search result is adjusted by using the probability.

According to another aspect, the present disclosure also provides an example data search processing system. The system may include a search front end, a log collector, a data analysis platform, a data storage system, and a search engine. The search front end receives a search request sent by a current user to obtain one or more query words included in the search request, and forwards the search request sent by the current user to a query analyzer. The log collector collects historical operating information of the user relating to a data object in a search result corresponding to the query words. The data analysis platform uses an attribute of the data object as a specified attribute and generates a probability distribution model of attribute values on the specific attribute of the data object by using the historical operating information of the data object in the search result corresponding to each query word. The search engine conducts searching of the correspondingly obtained query words according to the search request sent by the current user, computes a probability corresponding to the attribute value of each data object on the specified attribute in the research result of the query word by using the probability distribution model, and adjusts an output rank of the data object in the search result by using the probability.

According to a further aspect, the present disclosure also provides a data search processing method. Historical operating information of the user relating to a data object in the search result corresponding to each query word is collected. An attribute of the data object is used as a specified attribute. A probability distribution model of the attributed value of data objects on the specified attribute is established by using the historical operating information of the data object in the search result corresponding to each query word. A corresponding relationship between the query word and the probability distribution model is recorded. After a search request sent by a current user is received, a query word included in the search request is obtained. A probability distribution model corresponding to the query word in the search request is determined according to the corresponding relationship between the query word and the probability distribution model. A probability corresponding to the attribute value of each data object on the specific attribute in the research result corresponding to the search request sent by the current user is calculated by using the probability distribution model. A rank of the data objects in the search result corresponding to the search request is adjusted by using at least the probability.

With respect to network search platforms which may search data objects from various content providers and are not completely subject to data verification, the present techniques may effectively reduce the risk of accessing invalid data objects and suffering malicious data attack, guarantee the security and reliability of the search platforms, and further obtain trust of users to the search platforms. By analyzing actual search behaviors of a large amount of users, a mathematical modeling for most reasonable attribute values of each search word is established and a reasonability of the attribute values is considered as a reference when the data object are sorted for display. Thus, an opportunity of ranking unreasonable (invalid and malicious) data objects in priority is greatly reduced. Further, when the users automatically submit search requests through the network search platforms, the present techniques automatically obtain reasonable attribute values under current search purpose as a reference. In other words, the present techniques consider the reasonability of attribute values of the data objects for displaying the search result, thereby suppressing unreasonable data objects, preventing the unreasonable data objects from being provided to the users, improving the user search experience, and promoting a benign development of the search platforms.

### BRIEF DESCRIPTION OF THE DRAWINGS

The accompanying FIGs provide further illustration of the present disclosure and constitute a part of the present disclosure. The example embodiments and their illustrations are only used to illustrate the present disclosure, and are not intended to improperly limit the present disclosure.

FIG. 1 is a flowchart of an example data search processing method according to an example embodiment of the present disclosure.

FIG. 2 is a flowchart of an example method for generating model parameters and obtaining model parameters corresponding to query words according to an example embodiment of the present disclosure.

FIG. 3 is a diagram of an example data search processing system according to an example embodiment of the present disclosure.

FIG. 4 is a diagram of an example method for computing ranking scores by a search engine according to an example embodiment of the present disclosure.

FIG. 5 is a diagram of an example data search processing apparatus according to an example embodiment of the present disclosure.

### DETAILED DESCRIPTION

The present techniques establish probability distribution model parameters (a probability distribution model includes a probability distribution function, model parameter, etc.) corresponding to query words by analyzing actual operation behaviors, performed on search results obtained through the query words, of most users under the query words related to each search request from a large amount of search requests submitted by a large number of users. The probability distribution model parameters are used as a reference corresponding to the query words. The present techniques apply the model parameters to process displaying the search results of the search request for data objects from a current user. As the model parameter considers reasonability into account, when the search result is subject to display processing, results of one or more data objects. which are more accurate and valid (meeting search word target), more trustworthy, low-risks, shall be displayed in priority, and results of unreasonable and high-risk data objects are prevented from being displayed in priority. The present techniques improve display processing and display reasonability, reduce a user operation risk, enhance a search accuracy, security and reliability of search platforms, improve user search experience, and promote the benign development of the search platforms.

A clear description of the technical solutions will be made with reference to example embodiments of the present disclosure and corresponding companying FIGs in order to make the objects, technical solutions, and advantages of the present disclosure more apparent. Obviously, the example embodiments as described herein are only a part instead of all of the embodiments. All other embodiments obtained by those of ordinary skill in the art based on the example embodiments of the present disclosure fall within the protection scope of the present disclosure.

Along with the continuous improvement of Internet infrastructure and continuous development of computer networking technology (by taking a search technology of online shopping as an example), as an amount of products is large, users need a user interface (user search interface) and a product search engine to rapidly find desired products. At such an interface, when the users input keywords or select a category, the product search engine may return a product display list. Generally, product information displayed in the product display list may include items of product images, product description, product price, etc. Certain product information (item), such as product prices, has significant influence on users. A product price which is considerably higher than an expected product price of a user may ensure that a user skips the product and does not browse a detailed page of the product. Therefore, an opportunity that the user orders the product may be missed. Likewise, a product price which is considerably lower than a normal market price may cause the user to doubt the authenticity of the product. If a large amount of such similar phenomena occur in a product search platform, doubts on products sold by the current platform or security of the platform of users may arise. Particularly third-party vendors independent of search platforms may set unreasonable product prices purposefully, such as a high price, to influence a price rank of the product. Alternatively the product sold by vendors has quality problems (for example, imitation goods) and the price is considerably lower than a market price and thus the security may not be guaranteed and the quality is unreliable. The product, however, may be ranked higher because of low price. With respect to certain specific products, their market prices are relatively fixed. For example, a market price of a certain model of digital camera is relatively fixed. With respect to products corresponding to other query words, such as “cell phone” and “dress,” no fixed price ranges exist. With respect to such query words, it is difficult to set a reasonable price range to eliminate products with unreasonable price settings from search results. Therefore, in order to guarantee the security and reliability of search platforms and reduce the risk of buying malicious products, the search platform needs to obtain trust from the users and improve a search efficiency (for example, automatically digging the reasonable price range under each query) and a display processing efficiency (for example, using the price range to improve a product display sequence/rank), which requires improving display processing of product search results. Detailed description of the present disclosure is illustrated by taking product search as an example as follows.

In an example embodiment of the present disclosure, a network search platform used by users provides a user interface for a product search. A data object searched by a user request may be a product. A user may be a buyer searching products through an e-business website. A search request of a user may be performed by inputting a keyword or selecting a category on the user interface for a product search. Attributes of the data object may be product information, such as a product image, a product description, and a product price. Display processing may be ranking processing performed on searched data objects according to attributes of data objects. For example, products are ranked according to product prices and then are displayed in a list mode. Actual operation behaviors of users may be a selection operation (click, for example) to products in the searched result list. Providers of data objects may be all vendors providing product information.

Brief description of technical terms or glossary is as follows.

Key-value system: a storage system, in which contents are stored according to key and vale, capable of rapidly reading a corresponding value through a given key.

Map-reduce: a programming model simplifying parallel computation and a universal parallel computation framework provided by Google™, which is convenient for processing mass data (for example, 1T data) on large-scale clusters (for example, thousands of servers).

Double-Gaussian probability model: a particular case of Gaussian mixture model. Gaussian mixture model assumes that data distribution may come from a plurality of Gaussian distributions, parameters of each of Gaussian distributions may be different, and each of Gaussian distributions may have different prior probabilities.

EM algorithm: abbreviation for Expectation-maximization algorithm, capable of, with respect to a statistic model, acquiring optimized parameters of maximization likelihood through iterative computation.

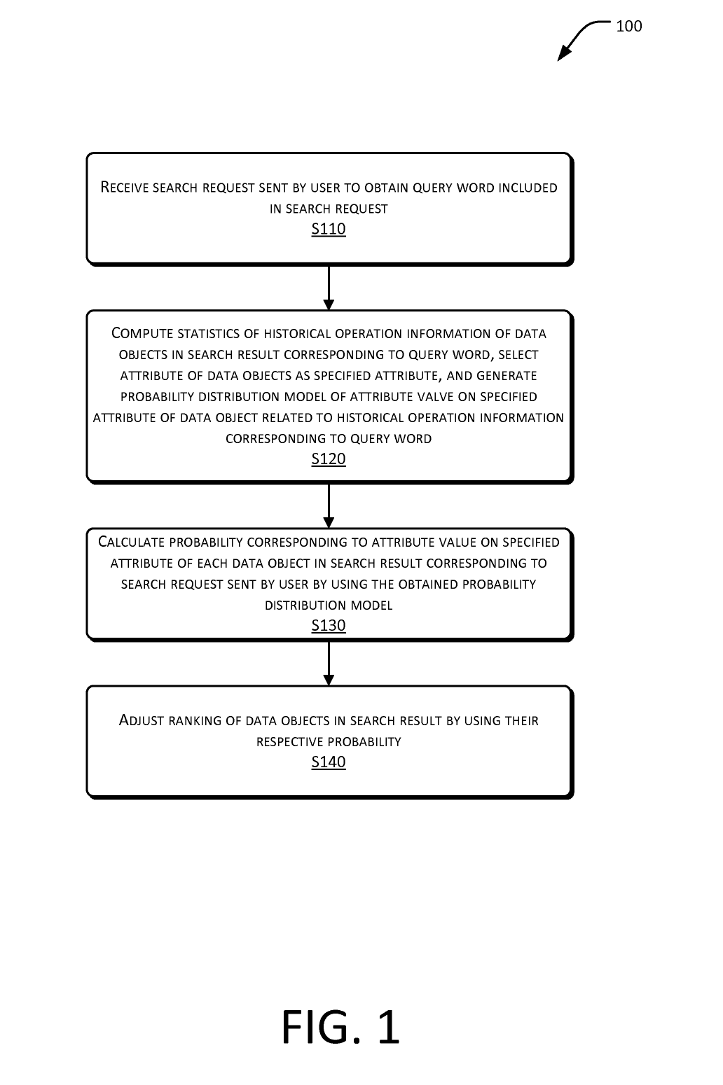

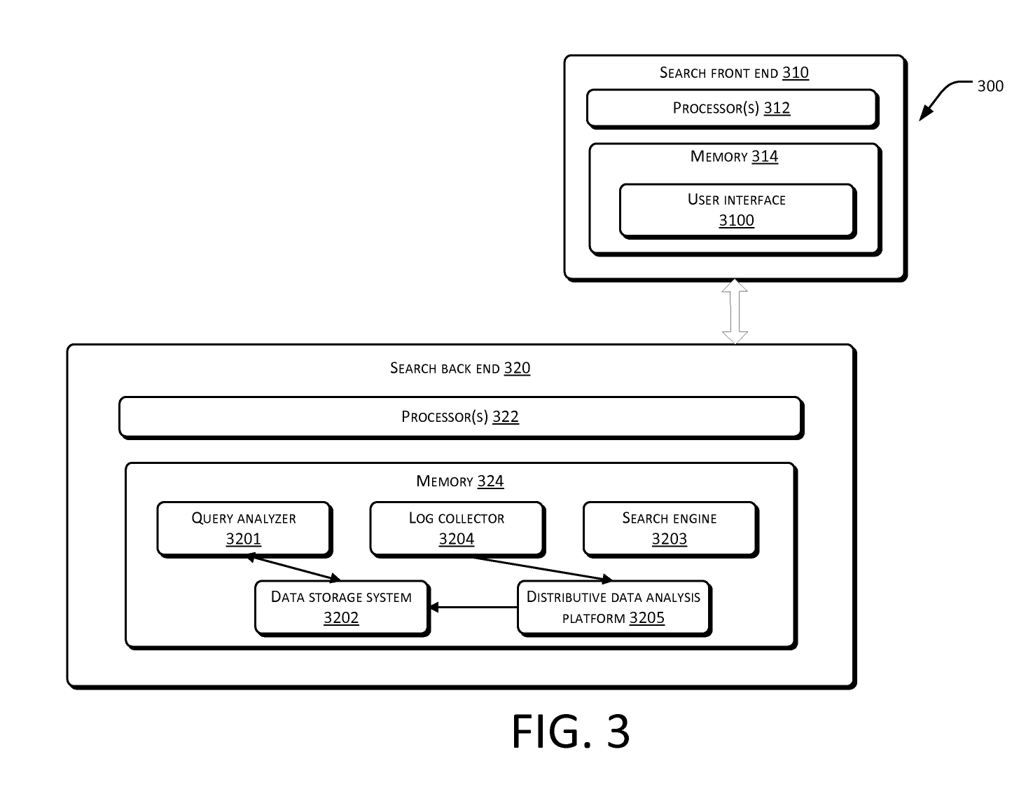

FIG. 1 shows a flowchart of an example data search processing method 100 according to an example embodiment of the present disclosure. FIG. 3 shows a diagram of an example data search processing system 300 according to the example method of the FIG. 1. Implementations of FIG. 1 and FIG. 3 are mere examples of users conducting a search among massive data objects by using the example methods of the present disclosure. The method of the present disclosure is not limited to the example embodiments.

The data search processing system 300 includes a search front end 310 and a search back end 320. The search front end 310 includes one or more processor(s) 312 or data processing unit(s) and memory 314. The memory 314 is an example of computer-readable media. The memory 314 may store therein a plurality of units including a user interface 3100.

The search back end 320 or search system includes one or more processor(s) 322 or data processing unit(s) and memory 324. The memory 324 is an example of computer-readable media. The memory 324 may store therein a plurality of units including a query analyzer 3201, a data storage system 3202 such as a key-value storage system, a search engine 3203, a log collector 3204, and a distributive data analysis platform 3205.

The user interface 3100 implements interaction with a user, receives search requests sent by the user, and outputs search results to the user. The search front end 310 may transmit the received search requests to the search engine 3203 at the search back end 320.

The user interface 3100 of the search front end 310 gathers (obtains) data generated during users' operation of the search results, and sends the data to the log collector 3204 of the search back end 320. The user interface 3100 of the search front end 310 may also transmit the search requests sent by the user to the query analyzer 3201 of the search back end 320 to analyze the search requests.

The search engine 3203 conducts a search according to the search requests from the users, and may also output search results to the search front end 310. The log collector 3204 collects operation data related to users' search results and acquired by the search front end 310 and supplies the operation data to the distributive data analysis platform 3205.

The distributive data analysis platform 3205 conducts analysis processing of historical operation information of users, including attribute values of specified attributes of the data objects and query word Q in the historical operation information, and generates a probability distribution model of search objects corresponding to the query word Q on the specified attributes. The model may include model parameters such as mean value parameters, variance parameters, priori probability parameters. etc. The model is stored in the data storage system 3202. If a capacity of the data storage system 3202 is not taken into account, the probability distribution model may also include probability distribution functions for probability calculation of the model parameters.

The query analyzer 3201 accesses the data storage system 3202, analyzes a current search request according to model parameters stored in the data storage system 3202, and returns information obtained from analysis to the search front end 310. Analyzed information and search requests may be provided by the search front end 310 to the search engine 3203.

The search engine 3203 obtains a search result according to the current search request, adjusts the search result according to the analyzed information, and then provides the adjusted search result to the search front end 310. The search front end 310 outputs the adjusted search result to the user.

Specific processing implementations of all parts of the system 300 are described step by step in all steps of embodiments in the following example method embodiment.

In step S110, the search request sent by a current user is received to obtain a query word included in the search request.

The search request includes the query word Q. The search request is to, according to the query word, search one or more data objects corresponding to the query word and desired by the current user.

For example, the search request sent by the current user is received by the search front end 310 of a network search platform. For instance, the user may request to search data objects by inputting keywords into an input box of a user search interface or by selecting (clicking, for example) a search word or a category recommended on the search interface. The search request is transmitted by the search front end 310 to the search back end 320 of the network search platform. The search request may include the query word Q, namely information such as the above input key word or clicked category, which is transmitted to the search back end 320 along with the search request.

By using an online shopping product as an example, an online shopping user, i.e., a buyer, inputs a product name or selects a listed product category at a product search user interface. In other words, the interface receives the product search request sent by the current user. The product search request includes the query word Q (such as an input product name and clicked product category) for searching a product. The buyer expects to search one or more products he/she desires to buy and that conform to the query word through the query word Q included in the product search request.

In step S120, statistics of historical operation information occurred to data objects in the search result corresponding to the query word are computed according to the obtained query word. An attribute of the data objects is selected as a specified attribute. A probability distribution model of the attribute value on the specified attribute of the data object related to the historical operation information corresponding to the query word is generated.

Therefore, the probability distribution model (model parameters) corresponding to the query word is obtained from one or more probability distribution models corresponding to one or more query words.

For example, a query word included in the search request is obtained according to the search request sent by the current user. For instance, the current search request is forwarded to the query analyzer 3201 from the search front end 310, and then the query word is extracted. Then, according to the query word, the probability distribution model or probability distribution model parameters of the attribute value of the data object on the specified attribute corresponding to the query word is obtained.

For example, historical operation information of the data object corresponding to the query word in the search result may be subject to statistics analysis. An attribute of the data object is selected as a specified attribute. The probability distribution model of the attribute value of the data object, on the specified attribute, related to the historical operation information corresponding to the query word is generated. Therefore, corresponding probability distribution model/model parameters are obtained according to the query word, which may be stored in a key-value mode (for example, a key-value storage relationship), or be used to update the former key-vale pair (query word and model), and further the model/model parameters may also be directly used.

For another example, the query word was previously searched to obtain data objects. Historical operation information of the data objects was subject to statistics analysis. An attribute of the former data object is selected as a specified attribute. The probability distribution model of the attribute value of the data object that is related to the operation information corresponding to the query word on the specified attribute is generated and stored. With respect to the query word at the present time, a model (or the model parameters) corresponding to the query word in the current search request may be found out directly from all models of all stored corresponding query words. When operation information occurs on the data object searched at the present time by the query word, the corresponding probability distribution model is updated. Further, the query and the probability distribution model may also be recorded according to a corresponding relationship of key-value pair, such as a key-value storage relationship. The probability distribution model corresponding to the query word in the current search request may be determined through the query word. For instance, the query analyzer 3201 uses the query word as the key to find out the value, i.e., a model (parameter), stored in an online key-value system corresponding to the key.

For example, the search front end 310 may firstly forward a search request to the query analyzer 3201 after obtaining the search request of the user. The query analyzer 3201 analyzes the search request of the user. The analysis includes obtaining a model corresponding to the query word (Q) in the current search request from one or more models stored in the data storage system 3202 according to the query word (Q) of the search request. The model may include model parameters, which may be represented by a set of parameters.

In addition, analysis to the search request of the user by the query analyzer 3201 may also include automatic error correction, synonym rewriting, category predication, etc.

Automatic error correction includes correcting query words with spelling errors into correct query words. For example, “Nokie” is corrected as “Nokia.”

Synonym rewriting includes using another synonym to replacing the query word in the search request. For example, “Nokia” is rewritten as “ [symbol] ” in Chinese.

Category predication includes predicating categories of data objects corresponding to the query words. For example, “apple” input by the user may be an apple in fruit or an Apple™ phone, which respectively belong to categories of fruit and mobile phone. By using category predication processing, the probabilities of the query word apple belonging to the two categories of data objects are respectively 0.5 and 0.5.

The data storage system 3202 may adopt a key-value system and store all models generated in the data storage system 3202. The probability distribution model corresponding to the query word by using the historical operation information on the data object in the search result corresponding to the query word in the current search request of the user is generated or established. For example, the model or optimal model parameters may be obtained according to the statistic analysis of the attribute value of the data object, on the specified attribute, in the historical operation information.

By using an online shopping product as an example, a buyer may send a search request by inputting a product name or selecting a listed product category. The search request includes product names input or product categories selected by a vendor. The search request is forwarded to the query analyzer 3201 of the search system 320. The query analyzer 3201 performs analysis processing of the search request. The analysis mainly obtains a price model corresponding to the product related to the search request (i.e., price model parameters corresponding to the product is obtained).

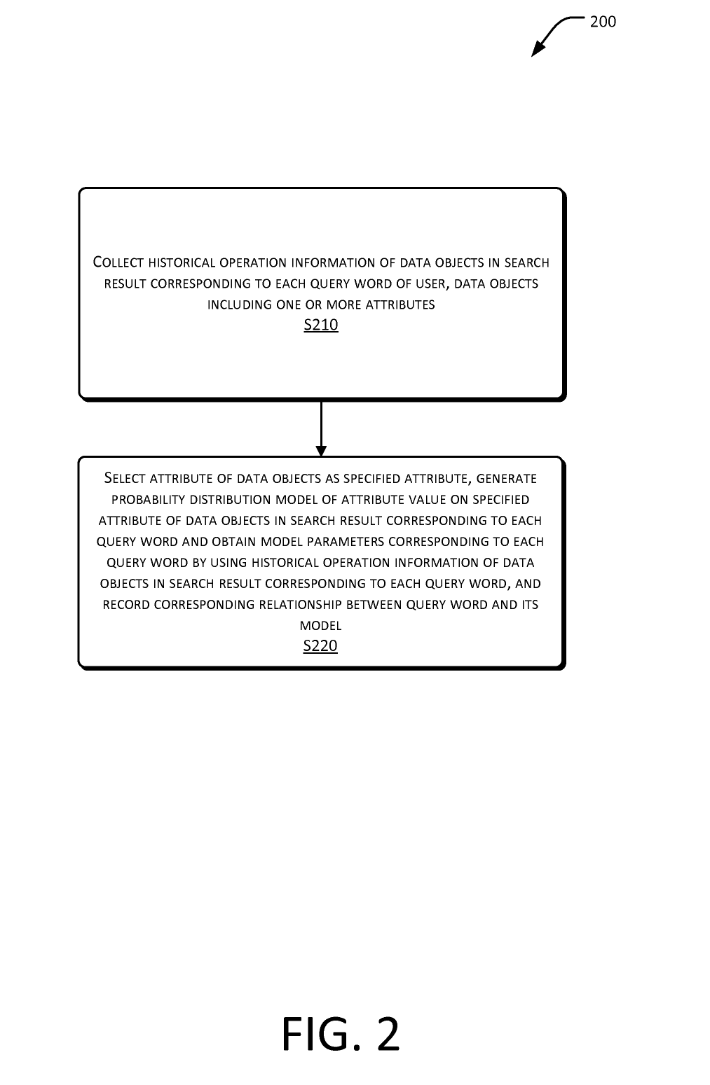

FIG. 2 shows a flowchart illustrating an example method 200 for generating the model parameters and obtaining a model corresponding to the current query word according to an example embodiment of the present disclosure. By using the data storage system 3202 such as the key-value system as an example, after the model (or model parameters/model parameter set) is generated, the model and the query word Q may be stored in the key-value system in a key-value mode. This is only one example and the method for obtaining model parameters of the present disclosure is not limited to the example.

Historical operation information on the data object in the search result corresponding to each query by the user may be counted according to historical logs. With respect to a certain query word, each data object in the corresponding search result includes one or more attributes, and an attribute may be selected as the specified attribute. The probability distribution model (namely probability model or attribute model) of the attribute value of the data object, on the specific attribute, in the search result corresponding to the query word is generated and stored by using the historical operation information of the user to the data object. The probability distribution model includes probability distribution functions (for example, Gaussian probability distribution) and model parameters selected in advance. The model may be shown through a parameter set, such as a variance m, a mean value σ, and a priori probability.

In step S210, historical operation information of the data object in the search result corresponding to each query word of the user is collected.

The user may request to obtain one or more data objects relevant to the query word through the query word (Q) included in the quest request. If the one or more data objects are searched, the searched data objects are served as search results to be output to the user sending the search request. The user may operate the results and the operation includes selecting certain data object, etc. The operation information generated during the operation is obtained and recorded in logs, and along with the collection and storage of the logs, the operation information on the data object corresponding to the query word of the user is gradually collected as historical operation information. The searched data object includes one or more attributes. Different data objects may have different attribute values in a certain attribute. For example, a product may have different price values (attribute values) in the price attribute.

For example, the search engine 3203 may conduct the search processing of one or more data objects desired by the user according to the query word Q in the search request of the user, and display and output the searched one or more data objects corresponding to the query word, which is served as a search result to the user through the user interface 3100. For example, the one or more data objects are displayed in a list mode, and include one or more attributes and corresponding attribute values. If the user is interested in certain data objects such that the user hopes to know the data objects in more detail, the results may be operated such that, when certain data object is clicked to browse more information, user operation information on the data object corresponding to the query word is generated. The operation information at least includes the query word Q corresponding to the data object, and the attribute value of the data object on the specified attribute. The operation information also includes user ID, operation occurrence tie, etc. The user operation information may be collected or obtained by the user interface 3100, recorded in logs, and sent to the log collector 3204 of the search back end 320. The log collector 3204 collects the operation information, and the operation information is served as historical operation information during subsequent processing. The logs and operation information recorded by the logs may be stored in the distributive computing platform 3205.

By using online shopping product as an example, the search engine 3203 searches various products supplied by vendors according to product names in the product search request to obtain one or more products with product names including the query word. The search engine 3203 finds out corresponding products supplied by all the vendors according to the product names and returns the products to the buyer requesting the search. In this example embodiment, data object is product information. The data object includes product ID, product images, image description, product prices and other attribute values. The searched products are ranked according to product prices or sales volume, and are displayed to the buyers in a list mode (for example, the products are loaded to browse sides of the buyers shown in FIG. 3). If a user is interested in a certain product in all the displayed products, the product will be clicked to obtain details. Therefore, the generated click data, such as the query word Q corresponding to the product, the product price (label size), click occurrence time, the user ID, the product ID other attributes and attribute values thereof, is served as click information collected by the user interface 3100 and recorded into logs. The log collector 3204 collects and stores the transmitted logs (click information).

In step 220, an attribute of the data object is selected as a specified attribute. The probability distribution model of the attribute value on the specified attribute of the data object in the search result corresponding to each query word is generated and the model parameters corresponding to each query word is obtained by using the historical operation information of the data object in the search result corresponding to each query word. The corresponding relationship between the query word and the model is recorded.

Firstly, the user operation information collected in step S210 may be subject to analysis processing. The operation information is used to establish the model. The analysis processing on the user operation information may be periodic, namely periodic analysis processing. A period (preset period) such as one moth is preset. Logs accumulatively stored by the user within the preset period are subject to analysis processing. Further, the analysis may be accomplished by the distributive computing platform 3205.

Analysis processing includes preprocessing the operation information. Data (massive data) relevant to operation, such as operation information, in logs may be analyzed through parallel computing such as map-reduce to determine the query word Q in the operation information and the attribute value of the data object related to the operation information on the specified attribute. Moreover, each query word Q and the attribute value of the data object related to the operation information under each query word of the user, on the specified attribute, are converged to form predetermined format record. The predetermined format may be query word Q: attribute value 1, attribute value 2, . . . . For example, N data objects are searched through the query word Q. The user clicks M data objects in the N data objects. In the M data objects, the attribute value of the specified attribute of data object M₁ is O₁, the attribute value of the specified attribute of data object M₂ is O₂, . . . , and the attribute value of the specified attribute of data object Mₘ is Oₘ. N and M are integers greater than or equal to 0. M is less than or equal to N. Oₘ indicates attribute value, and m and n are natural numbers. The attribute values of the specified attribute of the data objects in the operation information may be determined as O₁, O₂ . . . and Oₘ and query words Q through map-reduce parallel computing, and attribute values corresponding to query words Q are converged to form the above predetermined format record “Q: O1, O2, . . . Om” (Q-O format for short). Therefore, the attribute values of the specified attribute of the data objects in the operation information corresponding to all the query words Q may be converged, to form an attribute value set such as {O₁, O₂, . . . Oₘ}, and the attribute value set is optimized.

Then, a probability distribution model of the attribute value of the data object, on the specified attribute, relevant to the user operation information under each query word may be generated according to the predetermined format record (such as the Q-O format record of the attribute value of the specified attribute of the data object and the query word) obtained after preprocessing of the operation information, namely optimal model parameters corresponding to each query word may be obtained. The generated model will be stored in the data storage system in a key-value mode. Further, the processing of generation or establishing of the model may be accomplished by the distributive computing system 3205.

For example, the logarithm space of the attribute value O of the specified attribute of the data object corresponding to each query word Q in the Q-O may be subject to double-Gaussian probability model fitting so as to obtain the probability distribution model corresponding to the query word Q. In other words, the model parameters of maximization likelihood may be found out through iterative computation by using an EM algorithm with respect to the model during the double-Gaussian probability model fitting. Then the query word Q is taken as the key and the model parameter is obtained by fitting according to the historical operation information corresponding to the query word Q, which is served as a value. The model parameters corresponding to all query words Q are stored into the online key-value system 3202 in a “key-value” mode. Therefore, the query analyzer 3201 may obtain the model parameter corresponding to a query word from the key-value system 3202.

By using online shopping product as an example, the distributive computing platform performs analysis processing on the prices of products accumulatively clicked in the last month, and performs fitting on the product prices through the double-Gaussian probability model so as to obtain a price model or the price model parameters corresponding to the query words. For example, the distributive platform finds out product clicked prices from logs accumulated for one month (namely finds out data corresponding to “label” attribute of operation/click data objects), performs analysis processing so as to obtain Q-O format record, and then generates the price model to obtain model parameters. The double-Gaussian probability fitting algorithm is taken as an example as follows to illustrate the processing flow for performing analysis processing and obtaining optimal price model parameters. The implementation process described herein is only as an example and shall not be used to limit the present disclosure.

Firstly, a preprocessing of accumulated data in logs is performed as follows: (1)-(3).

(1) Logs of the same query word Q may be converged under a map-reduce parallel computing framework. Firstly, click prices of each query word Q is converged to form the following format record. For instance, a user finds out N products through the query word Q and clicks M products. In the price attribute of product, corresponding records between prices of the M clicked products and the query words are as follows:

Query words Q: price 1, price 2, price 3 . . . (i.e., a Q-O format record), for example:

“dress”: 100, 120, 111, 150, 180 and 230

(2) A product clicked price set of certain query word Q is obtained to perform price model computing on the query word Q.

From contents of logs in the last month, a price set S={p1, p2, p3, . . . pN} of all products clicked by user under certain query word Q may be converged through the Q-O format record. P stands for price and N is a natural number. |S| indicates a size of the set S, and in this example, |S|=N. When N is smaller than a certain threshold value or less than a preset threshold value, the price model is not computed for the query word Q. In other words, the quantity is small, and the price model is not desired to be specially computed. For example, in actual applications, the threshold value may be 100. If N is less than 100, the price model is not computed for the query word Q. If N is greater than 100, the price model is computed for the query word Q.

(3) a price filter value computation is performed and a filter value is used to filter the lowest price and the highest price to obtain a new clicked price set:

Ŝ={pᵢ|pᵢ≧P₁ and pᵢ≦Pₕ and pᵢεS}

Ŝ is filtered new clicked price set. pᵢ indicates a remaining clicked price element after noise data, such as 5% of the highest prices and 5% of the lowest prices in the set S, is filtered in the new set Ŝ, and i is a natural number which is less than or equal to N. Ŝ is obtained through filtering to reduce data noise.

(3-1) A low price filter threshold value P₁ is computed to filter the lowest prices within certain range, such as 5% of the lowest prices, which may be preset according to experiences of actual situations. Please refer to calculation formula \textcircled{1}.

A filtering percentage is preset according to experiences. As a gravity center of Gaussian distribution is in the middle area, unreasonable data at edges of the distribution may be removed so that the model may properly capture reasonable price data clicked by most users.

P₁=max_{argx}|{pᵢ|pᵢ≧x and pᵢεS}|≧0.95*|S| \textcircled{1}

The formula indicates to find a largest value x so that in original set S the ratio of the number of samples pᵢ greater than or equal to x is not less than 95%. P₁ is a low price filter threshold value, pᵢ is a certain price sample in the original set S, and x is a temporary parameter. The formula corresponds to a threshold value of 5% of low prices in the original sample distribution. For example, the set S of original clicked pieces is {1, 2, 3, 4, 5, 6, 7, 8, 9 and 10}, and the quantity of S is 10. If a threshold value is desired to be found out, which ensures that the quantity of samples greater than or equal to the threshold value is not less than 6 (or 60% of the original samples), there may be a plurality of threshold values, which are 4, 3, 2 and 1. By taking 4 as the threshold value, the quantity of samples greater than 4 is 6, in which the conditions are met. In addition, by taking 3 as the threshold value, the quantity of samples greater than 3 is 7, in which the conditions are also met, and so on. Finally P₁=4 or the largest threshold value satisfying the conditions is selected.

(3-2) A high price filter threshold value Pₕ is computed to filter the highest prices within certain range, such as 5% of the highest prices, and may be preset according to experiences. Please refer to calculation formula \textcircled{2}.

Pₕ=min_{argx}|{pᵢ|pᵢ≦x and pᵢεS}|≧0.95*|S| \textcircled{2}

The formula, similar to (3-2), indicates that a smallest value x is found out so that in original set S, the ratio of the quantity of samples pᵢ less than or equal to x is not less than 95%. Pₕ is a low price filter threshold value, pᵢ is a certain sample in the original set S, and x is a temporary parameter. The formula corresponds to a threshold value of 5% of high prices in the original sample distribution.

(3-3) A new clicked price set is formed by samples pᵢ meeting conditions in the original sample set S through Pᵢ and Pₕ.

Ŝ={pᵢ|pᵢ≧P₁ and pᵢ≦Pₕ and pᵢεS}

Secondly, a double-Gaussian fitting operation is performed according to a set obtained through the preprocessing.

(4) Firstly, a log variation is conducted to all samples pᵢ in the new clicked price set Ŝ as shown in as formula \textcircled{3} to obtain a new sample set D={x₁, x₂, . . . , x_{N}};

xᵢ=log(pᵢ+1) \textcircled{3}

pᵢ is a sample in filtered sample set Ŝ, xᵢ is a sample in a new sample set D, which is called a new sample, and the quantity of filtered sample set or the set volume N=|Ŝ|. i and N are natural numbers, and i is less than or equal to N.

(5) Then a double-Gaussian probability model fitting is performed on the logarithm space with respect to each price element pᵢ under each query word Q in the filtered clicked price set so that model parameters corresponding to the query word Q may be obtained. For example, in order to be convenient for computing, the double-Gaussian fitting is performed on a new set D obtained by log. For example, for the convenience of computation, the sample set {x₁, x₂, . . . , x_{N}} may be firstly assumed to be independently sampled, and consistently meet the following probability distribution. Please refer to calculation formula \textcircled{4}.

p(x|π,m₁,σ₁,m₂,σ₂)=π*G(x|m₁,σ₁)+(1−π)*G(x|m₂,σ₂) \textcircled{4}

Function G in the formula \textcircled{4} is a Gaussian probability distribution function:

$$G ( x \vert ( m , σ ) ) = \frac{1}{\sqrt{2 π} σ} {e}^{- \frac{{( x - m )}^{2}}{2 {σ}^{2}}}$$

The probability model includes two Gaussian components. The first Gaussian component's mean value is m₁, variance is σ₁, and priori probability is π. The second Gaussian component's mean value and variance are m₂ and σ₁ respectively. Any Gaussian distribution has two parameters, in which one is mean value m, and the other is variance σ. m1 and σ₁ are the mean value parameter and variance parameter of the first Gaussian distribution, and m2 and σ₂ are the mean value parameter and variance parameter of the second Gaussian distribution. π is the priori probability of the first Gaussian distribution, and (1−π) is the priori probability of the second Gaussian distribution. The two prior probabilities are between 0 and 1 respectively, and the sum of the two prior probabilities is 1. The parameters may be obtained from sample data through model training. In this example, {π, m₁, σ₁, m₂, σ₂} is adopted to indicate parameters of double-Gaussian probability model.

p( ) is a probability distribution function. For example, p(x)=1/N and the value range of random variable x is limited to {1, 2, 3 . . . N}. That is, x complies with certain probability distribution and has N value possibilities, and the value probability on each value is equal, which is 1/N. For example, in the online shopping search display example of the present disclosure, the random variable x refers to clicked prices.

If a sample data set is given, parameters of double-Gaussian distribution may be obtained. In the example of the present disclosure, parameters of double-Gaussian distribution may be obtained from the sample set D. Double-Gaussian fitting is to find out such a group of optimal parameters to enable the data likelihood to be maximized. Definition of data likelihood is as follows and refers to formula \textcircled{5}. For the convenience of computing, a log of the data likelihood may be calculated, or log-likelihood, which may refer to formula \textcircled{6}.

L(D|π,m₁,σ₁,m₂,σ₂)=Πᵢ₌₁^{N}p(xᵢ|π,m₁,σ₁,m₂,σ₂) \textcircled{5}

log(L(D|π,m₁,σ₁,m₂,σ₂))=Σᵢ₌₁^{N} log(p(xᵢ|π,m₁,σ₁,m₂,σ₂)) \textcircled{6}

With respect to computing optimal parameters, for example, the famous Expectation-Maximization (EM) iterative algorithm may also be used.

(a) Initialization of model parameters:

π,m₁,σ₁,m₂,σ₂

π may be initialized to be 0.5. That is, two Gaussian distributions are equal in probability without any priori knowledge exists. m₁ and m₂ may be two values randomly selected from the sample D, and σ₁ and σ₂ may be respectively initialized to be 1. The log-likelihood corresponding to the current model parameters is computed, i.e., the log of likelihood in formula \textcircled{6}, which is also called loss for the convenience of expression.

loss=log(L(D|π,m₁,σ₁,m₂,σ₂))

(b) Two steps are circularly performed, which are Step E and Step M:

Step E: weights of each sample on the two Gaussian components are calculated. An example detailed computational formula \textcircled{7} is as follows:

$${w}_{i 1} = \frac{p ( {x}_{i} \vert {m}_{1} , {σ}_{1} ) \cdot π}{p ( {x}_{i} \vert {m}_{1} , {σ}_{1} ) \cdot π + p ( {x}_{i} \vert {m}_{2} , {σ}_{2} ) \cdot ( 1 - π )}$$

$${w}_{i 2} = \frac{p ( {x}_{i} \vert {m}_{2} , {σ}_{2} ) \cdot ( 1 - π )}{p ( {x}_{i} \vert {m}_{1} , {σ}_{1} ) \cdot π + p ( {x}_{i} \vert {m}_{2} , {σ}_{2} ) \cdot ( 1 - π )}$$

i=1, 2, . . . , N. N is a natural number and indicates the size of set D|D|=N, i is a traversing of samples, and each step of iteration needs traversing all samples.

Step M: new model parameters and priori probability parameters for each Gaussian component are calculated as follows.

$${π}^{new} - \frac{{N}_{1}}{N}$$

$${m}_{1}^{new} - \frac{1}{{N}_{1}} {\sum }_{i = 1}^{n} {W}_{i 1} {x}_{i}$$

$${m}_{2}^{new} - \frac{1}{{N}_{2}} {\sum }_{i = 1}^{n} {w}_{i 2} {x}_{i}$$

$${σ}_{1}^{new} = \frac{1}{{N}_{1}} {\sum }_{i = 1}^{N} {{w}_{i 1} ( {x}_{i} - {m}_{1}^{new} )}^{2}$$

$${σ}_{2}^{new} = \frac{1}{{N}_{2}} {\sum }_{i = 1}^{N} {{w}_{i 2} ( {x}_{i} - {m}_{2}^{new} )}^{2}$$

N₁=Σᵢ₌₁^{N}wᵢ₁, and similarly N₂=Σᵢ₌₁^{N}wᵢ₂, wherein N is the size of a training sample set D, N1+N2=N, and wi1+wi2=1.

$$\frac{{N}_{1}}{N}$$

is a number between 0 and 1 and indicates the priori probability of the first Gaussian component, and similarly

$$\frac{{N}_{2}}{N}$$

is the priori probability of the second Gaussian component. As both wi1 and wi2 are not integers, N1 and N2 are numerical values less than or equal to N and are not always numerical values.

Then the log-likelihood corresponding to the new model parameters {π^{new}, m₁^{new}, σ₁^{new}, m₂^{new}, σ₂^{new}} is calculated as follows:

loss^{new}=log(L(D|π^{new},m₁^{new},σ₁^{new},m₂^{new},σ₂^{new})),

Then the following computation is performed:

Δ=|loss−loss^{new}|

There are two iterative computations or loss and loss^{new}. For each time, a new parameter value (and a corresponding log-likelihood) is obtained under the existing parameter value. Then the new parameter value is used as an existing value to perform iterative computation to obtain the next new parameter value till the difference value A of log-likelihood corresponding to parameter values at two adjacent steps is very small. Otherwise new model parameters

{π^{new},m₁^{new},σ₁^{new},m₂^{new},σ₂^{new}}

are assigned to {π, m₁, σ₁, m₂, σ₂} and Step E is performed again.

When the obtained loss difference Δ is less than a given threshold value (preset threshold value) or a number of iterations reaches a specified upper limit value, the iteration is finished. The model parameters obtained from the last iteration are assigned to the final model parameters

[symbol]

,\hat{m}₁,\hat{σ}₁,\hat{m}₂,\hat{σ}₂}

The final model parameters [symbol] , \hat{m}₁, \hat{σ}₁, \hat{m}₂, \hat{σ}₂} obtained at the end of iteration are model parameters corresponding to the query word Q.

(6) Then, model (price model) parameters corresponding to each query word Q may be stored into an online key-value system by using the query word Q as the key and model as the value. In other words, storage is performed by using the query word Q as the key and price model (parameter set) as the value.

In step S130, the probability corresponding to the attribute value on the specified attribute of each data object in the search result corresponding to the search request sent by the user is calculated by using the obtained probability distribution model.

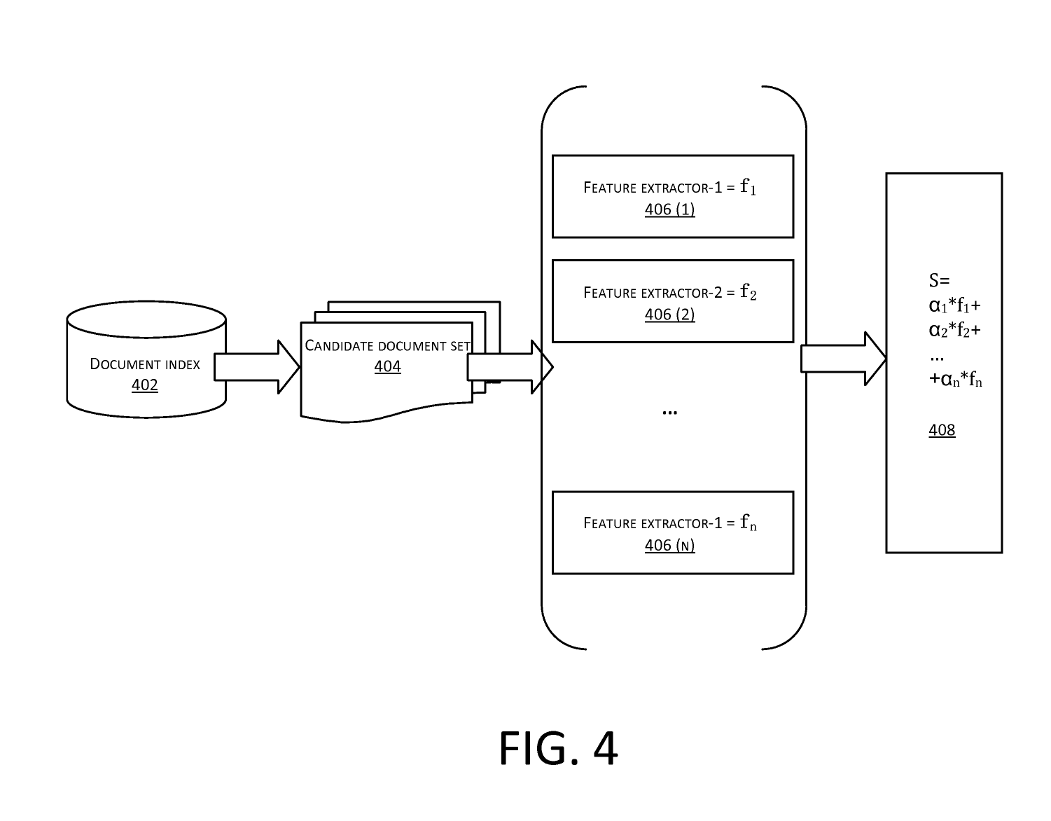

The specified attribute may be an attribute of the data object, which is set to be a dimension (feature) of the data object in the ranking computing of the search result of the present disclosure. The probability of the corresponding attribute value obtained through computation is the feature value of the data object on the dimension. The processing of ranking display of the feature value f on an additionally set dimension will be specifically described in a ranking step S140, which may refer to a schematic diagram of an example embodiment of outputting processing of the search result of a search engine related to the example method of the present disclosure in FIG. 4. The processing is merely an example, and the present disclosure is not limited to the example.

Firstly, the probability distribution model corresponding to the query word in the search request sent by the current user is returned, and combined with the current search request for conducting a search to obtain a search result.

For example, in step 120, the query analyzer 3201 obtains a model (model parameters corresponding to the query word Q) corresponding to the query Q related to the current search request from the online key-value system. The query analyzer 3201 returns the information to the search front end 310 of the user network search platform. Query analysis information is not necessarily to be output to the user (or the information is not output and displayed in the search user interface 3100 of the search front end 310), but is returned to the front end to be combined with the temporarily stored search request (combined with the query word Q, for example) to activate or trigger (prompt) the search engine 3203 to conduct search. That is, after the information and the search request are combined to be submitted to the search engine 3203 to conduct a condition search. The search request is sent to the search system 320 from the search front end 310, and is, on one hand, forwarded to the query analyzer 3201 to perform analysis so that analyzed information (model, model parameters and the like) is obtained, and on the other hand, continuously accumulated, computed, and analyzed as shown in FIG. 2 so that contents in the key-value system are prepared to be updated. For example, after the current search request is responded and the obtained data object is provided to the user, if the user operates the data object, new operation information may be gathered, collected and operated, and the model parameters are updated for the next search. Meanwhile, the original search request is also temporarily stored at the search front end 310 and waits analyzed information returned by the query analyzer 3201 so that the temporarily stored original search request (query word Q) and the obtained model and parameters corresponding to the query word Q are combined and submitted to the search engine 3203 to conduct the search request. The search engine 3203 conducts the search according to the query word Q in the search request, obtains one or more corresponding data objects, and returns them as the search result to be processed.

For example, the search engine 3203 may maintain a document index 402. A document index is similar to a word index attached to a book. With respect to each word, a document (d) ID list including the word is given and a document set corresponding to certain word may be rapidly found out according to the word, such as a set (product set) of one or more data objects. A candidate document set may be obtained by directly querying a document index. Therefore, in the present disclosure, for a given query word Q, the search engine 3203 may firstly obtain a candidate document set 404, namely the set of one or more data objects, under the query word Q through the document index. A determined set may be served as a search result to be processed and output.

By using an online shopping product as an example, the query analyzer 3201 of the search system 320 returns information such as a price model (parameters) corresponding to a product Q to be searched in a search request to the search front end 310. The search front end 310 submits the search request and the model parameters to the search engine 3203. The search engine 3203 conducts product search corresponding to the product Q and returns the search result to be processed. For example, a candidate product set for a given product name Q is obtained from a product index maintained by the search engine 3203.

Then a probability of the attribute value of each data object, on the specified attribute, in the search result corresponding to the search request sent by the current user is computed by using the determined probability distribution model.

For example, the search engine 3203 may compute feature values of a plurality of dimensions (features) for each document d (or data object or product) of the candidate document set. For instance, a feature extractor-1 406(1) obtains a feature value f₁, a feature extractor-2 406(2) obtains a feature value f₂, . . . and a feature extractor-n 406(n) obtains a feature value fₙ. Each dimension (feature) is preset in a search platform according to the requirements, and is configured to perform search result output display processing (such as output ranking processing) so as to conduct display according to a processed sequence. Each dimension feature value may be served as a function mapping related to the query Q and document (data object) d.

fᵢ=fᵢ(Q,d)

The probability distribution model (model parameters) of the data object on the specified attribute of the query word Q is used to conduct computation aiming at the attribute value of each search data object d, on the specified attribute, of the query word Q. The specified attribute may be served as a new dimension influencing output display sequence of one or more data objects d to be output (candidate). According to the attribute value of each data object d on the specific attribute and the model parameters, an attribute value probability or the feature value of the dimension may be obtained through a function. For example, the attribute value probability may be obtained through a probability distribution function corresponding to the model parameters.

By using online shopping product as an example, the attribute of product price is served as a new dimension (feature) of each product obtained by processing search to be output. Each product has a price value namely an attribute value on the price dimension. By using the model parameters in the model corresponding to the key word Q of product search to perform computation as shown in formula \textcircled{8}, and a feature value f_{price} is obtained.

f_{price}(x|Q)=p(log(x+1)|π^{Q},m₁^{Q},σ₁^{Q},m₂^{Q},σ₂^{Q}) \textcircled{8}

x indicates the price of the current product d, {π^{Q}, m₁^{Q}, σ₁^{Q}, m₂^{Q}, σ₂^{Q}} and indicate the double-Gaussian price model parameters corresponding to the query word Q.

In step S140, the ranking of the data object in the search result is adjusted by using the probability. At least the probability may be used to adjust the ranking of the data object in the search result corresponding to the search request of the current user to output and display the data object in the search result according to the ranking.

In the search result searched and returned by the search engine 3203, the probability of the attribute value of each data object on the specified attribute is obtained through computation of the combination of the model parameters and the attribute value of each data object on the specified attribute (please refer to step S130). The probability may be utilized to conduct racking processing (such as ranking score operation) to obtain a ranking score S of each data object, and the sequence of the data objects are output and displayed according to their respective scores. For example, the search result is output and displayed to the user through the user interface 3100 of the search front end 310. When the user operates the data objects in the search result, operation information of the current search may be collected through the collection operation in step S210, and the probability distribution model of the current query word may be updated through the model generation operation in step S220, which is to be used for the next time.

Therefore, the output processing of the search result may be further adjusted or affected/improved based on the query word Q and the former model parameters. In other words, the priority ranking of output or the sequence of result display is affected. To a certain extent, certain results more aligned with user expectation may be preferentially ranked in the front to be output to users. The adjustment may be realized by adjusting the ranking logic of a search result during the process of output result processing through the search engine 3203.

The ranking logic of the search result may be adjusted according to ranking score computation. Please refer to FIG. 4. For example, the ranking logic of the search result may adopt formula \textcircled{7}. Extracted multiple dimension features (f₁, f₂, . . . fₙ) are subject to linear weighting to obtain the ranking score S or a value of the data object under the query word Q. n is a natural number, and α₁, α₂, . . . αₙ are weights corresponding to each feature respectively.

S=S(Q,d)=α₁*f₁+α₂*f₂+ . . . +αₙ*fₙ \textcircled{7}

The score S 408 is the final ranking score, and f₁, f₂, . . . fₙ are feature values of the data objects corresponding to the query word Q on different dimensions (features). The dimensions may be pre-assigned or set through a search platform according to the requirements and have corresponding feature values, such as attribute value probabilities (or feature values) on specified attributes in step S130. Weights α₁, α₂, . . . αₙ corresponding to the features may be preset or obtained according to practical conditions of the query word Q, the search platform, etc., such as an on-line A/B test. The features or dimensions may be preset through the search platform according to requirements and have corresponding feature values (such as probabilities of attribute values on the specified attribute).

By using the network product search display as an example, the query word Q includes a plurality of words. A first dimensional feature may be a number of occurrences of the query words Q in a text description of a searched product. A second dimensional feature may be a length of the text description of the searched product. A third dimensional feature may be a matching degree between a category of the searched product and a category of the query word, etc.

The output rank of the search result is adjusted in view of the specified attribute according to the data objects searched by the query word Q in the current search request. In other words, a feature may be added in the ranking operation (logic) of the search request or the specified attribute is served as a new dimensional feature and a weight relevant to the feature is obtained to affect the ranking score value. S=S(Q, d)=α₁*f₁+α₂*f₂+ . . . +αₙ*fₙ+α_{new}*f_{new}, wherein α_{new} and f_{new} represent the newly added feature weight and the newly added feature respectively. The rank effect of the search result may be changed because of the newly added feature.

By using online shopping product as an example, the search logic of the search engine accomplishes ranking searched products according to product name Q to display and output the products to the user according to the price model parameters. Such logic may refer to formula \textcircled{7}. The feature values of multiple dimensions for each product of a candidate set are calculated (or obtained through a feature extractor). The linear weighting is performed on the multiple feature values to obtain the final ranking score S, wherein f₁, f₂, . . . fₙ are feature values of the product on different dimensions respectively, and α₁, α₂, . . . αₙ are corresponding feature weights respectively. The features of the product may include a sales volume, a credibility of a product vendor, a text relevancy between the query word Q and a text description of the product. Moreover, if the output result display effect needs to be changed according to the product price, a feature or the product price (a specified attribute is served as a dimension feature) is newly added in the search ranking operation. A calculation of such feature may refer to formula \textcircled{8}. The probability of the price (attribute value) of each product is served as the feature value or f_{new}=f_{price}. Weight α_{new} corresponding to the price feature of the product is obtained through on-line A/B test. Then the ranking score S of each product is calculated.

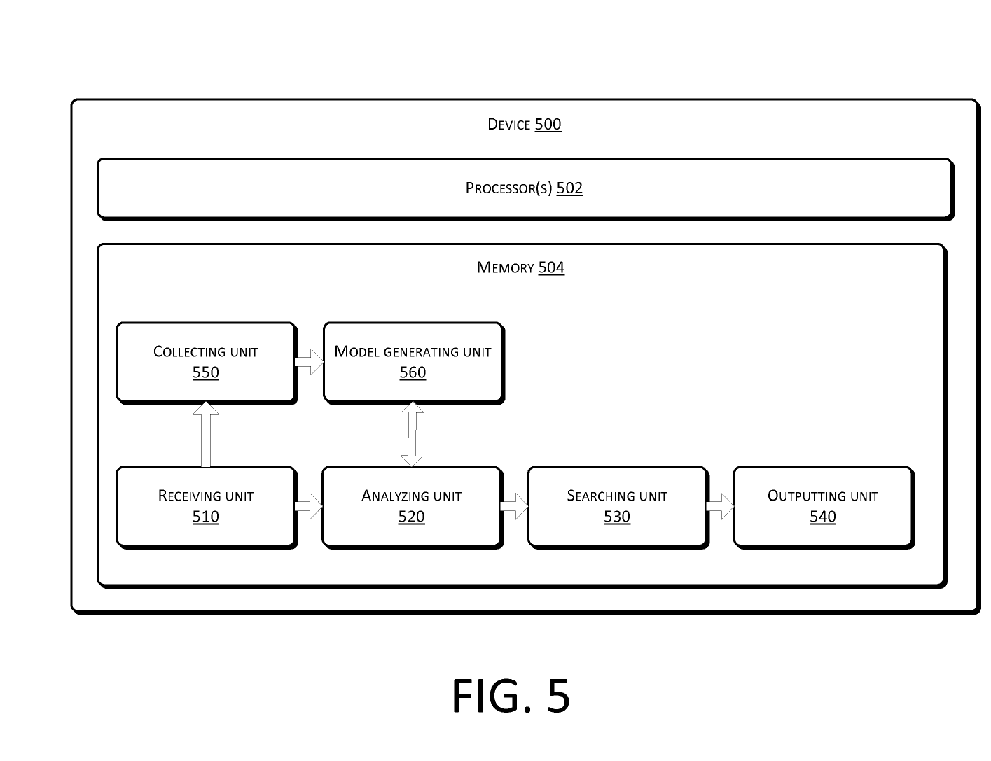

The present disclosure also provides an example data search processing device. FIG. 5 shows an example embodiment of the data search processing device. In FIG. 5, an example device 500 includes one or more processor(s) 502 or data processing unit(s) and memory 504. The memory 504 is an example of computer-readable media. The memory 504 may store therein a plurality of units including a receiving unit 510, an analyzing unit 520, a searching unit 530, an outputting unit 540, a collecting unit 550, and a model generating unit 560.

The receiving unit 510 receives a search request sent by a current user (details refer to step S110).

The analyzing unit 520 receives the search request transmitted by the receiving unit 510, obtains a probability distribution model that is generated by the model generating unit 560 corresponding to a query word based on the search request, and provides the probability distribution model to the searching unit 530 (details refer to step S120). The analyzing unit may include an obtaining unit (not shown in the FIGs) that obtaining the query word from the search request (details refer to step S1201), a determining unit (not shown in the FIGs) that finds out a correspondingly stored probability distribution model according to the obtained query word and provides the probability distribution model to the searching unit 530 (details refer to step S1202).

The searching unit 530 executes the search according to the model from the analyzing unit 520 and the search request from the receiving unit 510, returns a search result to be processed, and computes an attribute value probability on the specified attribute of each data object in the search result by using the model (details refer to step S130).

The outputting unit 540 adjusts an output ranking of the search result according to the probability and outputs an output sequence calculated after adjustment to the user (details refer to step S140).

The collecting unit 550 outputs one or more data objects, which are served as the search result, searched through the search request, to the user sending the search request. The user operates on the one or more data objects. The collecting unit 550 collects one or more logs that records operation information generated according to the operation to the search result by the user, and stores the collected one or more logs (details refer to step S210).

The model generating unit 560 periodically analyzes and processes the stored logs, generates the probability distribution model (model parameter set) corresponding to the query word according to the historical operation information related to the logs, determines optimal parameters, and stores the optimal parameters corresponding to the query word in a preset form (details refer to step S220).

In a standard configuration, a computing device, such as the device, the front end or the back end of a system as described in the present disclosure may include one or more central processing units (CPU), one or more input/output interfaces, one or more network interfaces, and memory.

The memory may include forms such as non-permanent memory, random access memory (RAM), and/or non-volatile memory such as read only memory (ROM) and flash random access memory (flash RAM) in the computer-readable media. The memory is an example of computer-readable media.

The computer-readable media includes permanent and non-permanent, movable and non-movable media that may use any methods or techniques to implement information storage. The information may be computer-readable instructions, data structure, software modules, or any data. The example of computer storage media may include, but is not limited to, phase-change memory (PCM), static random access memory (SRAM), dynamic random access memory (DRAM), other type RAM, ROM, electrically erasable programmable read only memory (EEPROM), flash memory, internal memory, CD-ROM, DVD, optical memory, magnetic tape, magnetic disk, any other magnetic storage device, or any other non-communication media that may store information accessible by the computing device. As defined herein, the computer-readable media does not include transitory media such as a modulated data signal and a carrier wave.

It should be noted that the term “including,” “comprising,” or any variation thereof refers to non-exclusive inclusion so that a process, method, product, or device that includes a plurality of elements does not only include the plurality of elements but also any other element that is not expressly listed, or any element that is essential or inherent for such process, method, product, or device. Without more restriction, the elements defined by the phrase “including a . . . ” does not exclude that the process, method, product, or device includes another same element in addition to the element.

One of ordinary skill in the art would understand that the example embodiments may be presented in the form of a method, a system, or a computer software product. Thus, the present techniques may be implemented by hardware, computer software, or a combination thereof. In addition, the present techniques may be implemented as the computer software product that is in the form of one or more computer storage media (including, but is not limited to, disk, CD-ROM, or optical storage device) that include computer-executable or computer-readable instructions.

The above description describes the example embodiments of the present disclosure, which should not be used to limit the present disclosure. One of ordinary skill in the art may make any revisions or variations to the present techniques. Any change, equivalent replacement, or improvement without departing the spirit and scope of the present techniques shall still fall under the scope of the claims of the present disclosure.

What is claimed is:

1. A method comprising:
receiving a search request of a user;
obtaining a query word included in the search request;
computing statistics of historical operation information of one or more data objects in a search result corresponding to the query word;
selecting an attribute of the one or more data objects as a specified attribute and generating a probability distribution model of one or more attribute values of the one or more data objects on the specified attribute;
computing a respective probability of a respective attribute value of a respective data object of the one or more data objects on the specified attribute by using the probability distribution model; and
adjusting an output ranking of the one or more data objects in the search result by using the respective probability.

2. The method of claim 1, wherein the selecting the attribute of the one or more data objects as the specified attribute and generating the probability distribution model of the attribute value of the one or more data objects on the specified attribute comprises:
preprocessing collected historical operation information;
determining the respective attribute value of the respective data object, corresponding to the query word in the historical operation information, on the specified attribute; and
forming a predetermined format record of the query word and the respective attribute value of the respective data object on the specified attribute.

3. The method of claim 2, further comprising:
generating the probability distribution model in the predetermined format record according to the respective attribute value in the predetermined format record by using a probability distribution model fitting algorithm; and
storing a corresponding relationship between the query word and the probability distribution model in a key-value form.

4. The method of claim 2, wherein the preprocessing the collected historical operation information comprises periodically preprocessing the collected historical information.

5. The method of claim 1, wherein the adjusting the output ranking of the one or more data objects in the search result by using the respective probability comprises:
computing a respective ranking score of the respective data object by using the respective probability corresponding to the respective data object as a respective feature value in ranking; and
ranking the one or more data objects according to their respective ranking scores.

6. The method of claim 5, further comprising outputting the ranked one or more data objects to the user.

7. The method of claim 1, wherein the historical operation information comprises the respective data object corresponding to the query word related to an operation of the user and the respective attribute value of the respective data object on the specified attribute.

8. The method of claim 7, wherein the probability distribution model is a double-Gaussian probability model.

9. The method of claim 1, wherein the selecting the attribute of the one or more data objects as the specified attribute and generating the probability distribution model of the attribute value of the one or more data objects on the specified attribute comprises:
using historical operation information corresponding to the query word to fit the probability distribution model; and
determining model parameters of the probability distribution model.

10. A system comprising:
a log collector that collects historical operation information related to one or more data objects in a search result corresponding to a query word;
a data analysis platform that selects an attribute of the one or more data objects as a specified attribute and generates a probability distribution model of one or more attribute values of the one or more data objects on the specified attribute by using the historical operation information; and
a search engine that obtains a search result corresponding to the query word, computes a respective probability of a respective attribute value of a respective data object of the one or more data objects on the specified attribute by using the probability distribution model, and adjusts an output ranking of the one or more data objects in the search result by using the respective probability.

11. The system of claim 10, further comprising a front end that receives a search request from the user to obtain the query word.

12. The system of claim 10, wherein the data analysis platform further:
preprocesses the collected historical operation information;
determines the respective attribute value of the respective data object, corresponding to the query word in the historical operation information, on the specified attribute; and
forms a predetermined format record of the query word and the respective attribute value of the respective data object on the specified attribute.

13. The system of claim 12, wherein the data analysis platform further periodically preprocessing the collected historical information.

14. The system of claim 12, wherein the data analysis platform further:
generates the probability distribution model in the predetermined format record according to the respective attribute value in the predetermined format record by using a probability distribution model fitting algorithm; and
stores a corresponding relationship between the query word and the probability distribution model in a key-value form.

15. The system of claim 10, wherein the search engine further:
computes a respective ranking score of the respective data object by using the respective probability corresponding to the respective data object as a respective feature value in ranking;
ranks the one or more data objects according to their respective ranking scores; and
outputs the ranked one or more data objects to the user.

16. The system of claim 10, wherein the historical operation information comprises the respective data object corresponding to the query word related to an operation of the user and the respective attribute value of the respective data object on the specified attribute.

17. The system of claim 10, wherein the probability distribution model is a double-Gaussian probability model.

18. The system of claim 10, wherein the data analysis platform further:
uses historical operation information corresponding to the query word to fit the probability distribution model; and
determines model parameters of the probability distribution model.

19. One or more memories stored thereon computer-executable instructions executable by one or more processors to perform operations comprising:
obtaining historical operation information of one or more data objects in a search result corresponding to a query word for one or more users;
selecting an attribute of the one or more data objects as a specified attribute;
generating a probability distribution model of one or more attribute values of the one or more data objects on the specified attribute according to the historical operation information; and
recording a corresponding relationship between the query word and the probability distribution model.

20. The one or more memories of claim 19, wherein the operations further comprise:
receiving a search request from a current user, the search request including the query word;
computing a respective probability of a respective attribute value of a respective data object in a search result on the specified attribute by using the probability distribution model; and
adjusting an output ranking of the respective data object in the search result by using the respective probability.
